(19) United States
(12) Patent Application Publication
(10) Pub. No.: US 2026/0251174 A1
(43) Pub. Date: Aug. 27, 2026

(54) DRIVE SHAFT

(71) Applicant: CP Tech GmbH, Büren (DE)

(72) Inventor: Thomas Joseph CASEY, Paderborn (DE)

(73) Assignee: CP Tech GmbH, Büren (DE)

(21) Appl. No.: 19/159,393

(22) PCT Filed: Feb. 21, 2024
(86) PCT No.: PCT/EP2024/054440

§ 371 Date: Aug. 25, 2025

(30) Foreign Application Priority Data
Feb. 27, 2023 (EP) 23158802.1

(51) Int. Cl. F16C 3/02; B23P 15/00; F16D 3/205

(52) U.S. Cl. CPC F16C 3/02; B23P 15/00; F16D 3/2055; F16D 2200/0021; F16D 2250/0023; F16D 2250/0053

(57) ABSTRACT

A drive shaft for the drive train of a motor vehicle includes a shaft body at least one end of which is provided with a tripod spider. The tripod spider has at least three tripod trunnions for receiving a roll unit each, and the tripod spider is formed by a formed section of the shaft body.

The invention relates to a drive shaft for the drive train of a motor vehicle, comprising a shaft body that is provided, on at least one end, with a tripod star that has at least three tripod journals for holding a rolling unit, in each instance.

In order to transfer the drive torque of a vehicle drive to to the vehicle wheels, constant velocity joints are used in the side shafts, wherein not just changes in angle between the vehicle wheels and the vehicle drive must be equalized, but also changes in length must be compensated. For this reason, the constant velocity joint on the wheel side is usually configured as a fixed joint, whereas the constant velocity joint on the transmission side regularly has an axial displacement possibility. On the drive side, the constant velocity joint is preferably structured as a tripod joint. In this regard, the tripod joint comprises an outer joint part and an inner joint part held by the former, having a central body on which three journals are formed, by means of which journals a tripod star is formed. On the journals, a rolling body is arranged, in each instance, which body is mounted on the journal by way of a needle bearing. The central part is configured as a ring part for attachment to a shaft. The connection between the central body and the shaft takes place by way of a spline that is formed both on the shaft and in the central body. Such a tripod joint is described, for example, in DE 10 2020 212 991 A1 and DE 11 2007 003 668 T5 .

The production of a drive shaft provided with a tripod joint proves to be very complicated. First, the tripod star is generally produced using a reshaping process, and is provided with a spline, wherein the shaft must also be provided with a spline. Subsequently, the tripod star must be applied to the shaft and axially secured in place, within the scope of the assembly process.

This is where the present invention takes its start. The invention is based on the task of making available a drive shaft having a tripod star for the drive train of a motor vehicle, which shaft can be produced with minimized effort. According to the invention, this task is accomplished by means of a drive shaft having the characteristics of claim 1.

With the invention, a drive shaft having a tripod star for the drive train of a motor vehicle is to be made available, which shaft can be produced with minimized effort. Because of the fact that the tripod star is formed by a reshaped section of the shaft body, a one-piece drive shaft is achieved, and thereby no complicated production of a gear mechanism and no installation of the tripod star on the shaft is required. Furthermore, due to the one-piece configuration, the transfer of greater torques is made possible, as compared to the shape-fit connection of shaft and tripod star that is formed by way of a gear mechanism. Preferably, the tripod star is formed by means of compression of the shaft. Particularly preferably, the drive shaft is formed as a forged part.

In a further development of the invention, the shaft body is configured to be hollow, in particular tubular. In this way, a weight reduction of the drive shaft is achieved.

In an embodiment of the invention, the shaft body has a thicker wall thickness in an end section that precedes the tripod journal of the tripod star as compared to a center, preferably cylindrical section. In this way, the torsional rigidity of the shaft is increased in the region of the tripod star, and thereby transfer of greater torques is made possible.

In a further embodiment of the invention, the drive shaft is produced from a steel alloy. In this way, cost-advantageous production is achieved, along with great strength, at the same time. Furthermore, on the basis of this material, hardening in certain regions is made possible. It is advantageous if the steel alloy is a high-performance steel, in particular 42 SiCrNbB 8-4, known under the trade name “CPDUR 2000.”

In a further development of the invention, the tripod journals are configured to be cylindrical and are preferably hardened. Preferably, the tripod star has three tripod journals distributed regularly over the circumference.

In an embodiment of the invention, particularly preferably, the tripod journals are provided with an axial bore. In this way, a further weight reduction is achieved.

In an embodiment of the invention, the shaft body has a tripod star at both of its two ends, wherein the tripod journals of the two opposite tripod stars are arranged offset from one another.

In a further development of the invention, the tripod journals hold a rolling unit, in each instance, which unit comprises a plurality of rolling bodies and is preferably formed by means of a needle bearing.

The invention is furthermore based on the task of making available a method for effort-minimized production of a drive shaft having a tripod star, for the drive train of a motor vehicle. According to the invention, this task is accomplished by means of a method having the characteristics of claim 11. In this regard, a tripod star is formed on a metal tube, in particular on a steel tube, on at least one end, by means of reshaping, in particular by means of compression, which star has at least three tripod journals, arranged circumferentially, after which process the tripod star is processed further by machining.

In a further development of the invention, reshaping takes place, at least in part, by means of a forging process. In this way, a homogeneous material structure can be achieved.

In an embodiment of the invention, the metal tube is formed in such a manner that a thicker crude wall thickness is formed in the region of the at least one tripod star than in the center region of the tube.

In a further embodiment of the invention, the at least one tripod star is hardened, at least in the region of its tripod journals. Preferably, the hardening process takes place by means of heat treatment, with low-pressure carburization and subsequent quenching. In this way, the mechanical properties of the edge layer, such as, for example, wear-resistance properties, are improved. Preferably, the quenching takes place by means of a high-pressure gas. By means of such “dry quenching” it is not necessary to clean the drive shaft after the heat treatment.

In a further development of the invention, the drive shaft is provided with a copper layer before hardening, at least in certain regions. In this way, coverage of regions that are not to be hardened is achieved, thereby preventing the absorption of carbon. Furthermore, reduced dimensional deviations occur due to the temperature-independent heat transfer during high-pressure gas quenching, along with improved mechanical properties, in particular improved fatigue properties, since no intergranular oxidation layer is formed.

Other further developments and embodiments of the invention are indicated in the other dependent claims. An exemplary embodiment of the invention is shown in the drawings and will be described in detail below. The figures show:

FIG. 1: the schematic representation of a drive shaft having:

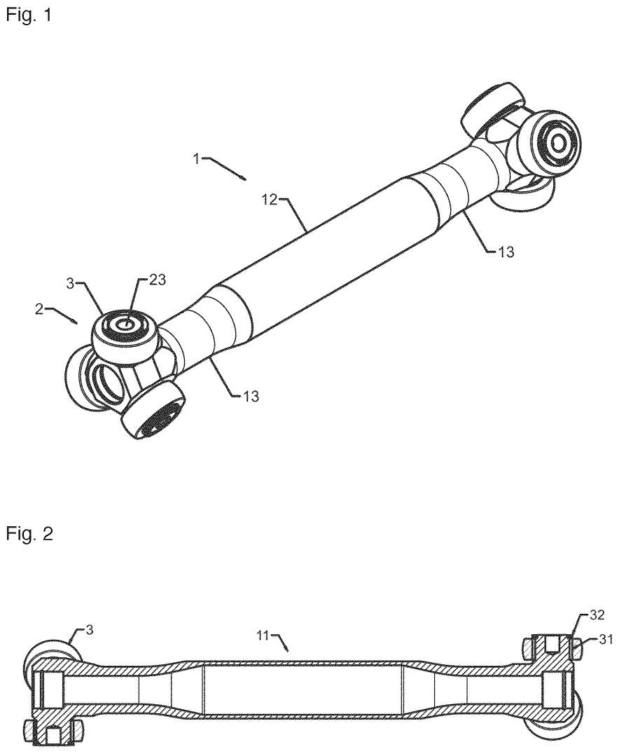

FIG. 2: the representation of the drive shaft from FIG. 1 in longitudinal section;

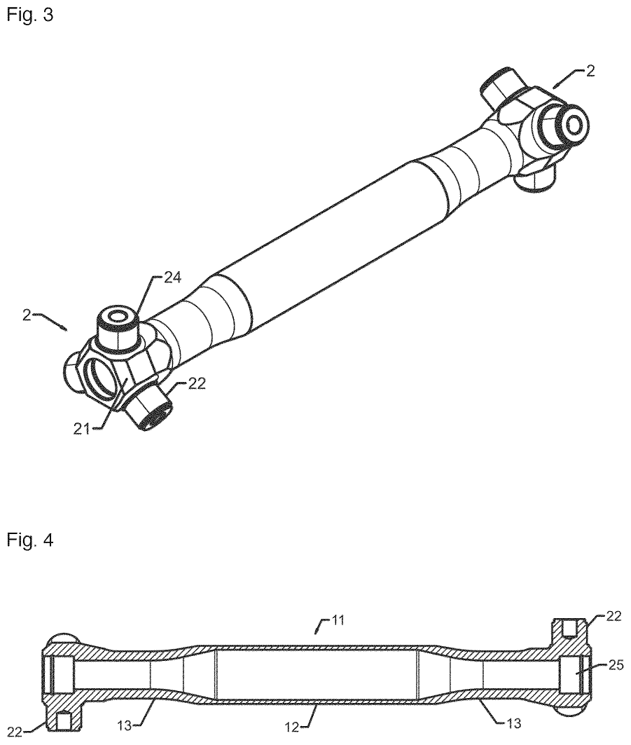

FIG. 3: the representation of the drive shaft from FIG. 1 without a rolling body, and

FIG. 4: the representation of the drive shaft from FIG. 3 in longitudinal section.

The drive shaft 1 chosen as an exemplary embodiment is produced from a steel alloy and comprises a tubular shaft body 11 having a center cylindrical section 12, which is followed, at both ends, by an end section 13 that has a decreased diameter. The two end sections 13 have a thicker wall thickness as compared to the cylindrical center section 12. On the end side, the two end sections 13 make a transition, in one piece, in each instance, into a tripod star 2.

The tripod star 2 comprises a tripod ring 21, on which three tripod journals 22 are formed circumferentially, offset from one another by 120 degrees, in each instance. In the center, the three tripod journals 22 are provided with an axial bore 23, in each instance. In the exemplary embodiment, the tripod journals 22 are configured to be surface-hardened. The two tripod stars 2 present on the shaft body 11, on the end side, are arranged with their tripod journals 22 offset from one another by 60 degrees.

A rolling unit 3 is applied to the tripod journals 22, in each instance, which units are mounted on the tripod journal 22 so as to rotate by way of a needle bearing 31. In this regard, the rolling units 3 are axially secured, in each instance, by way of a securing ring 32, which engage into a groove 34 that is provided on the tripod journal for this purpose.

The drive shaft 1 with the tripod stars 2 arranged on it is produced in one piece from a cylindrical tube, by means of a reshaping process. In this regard, first a forged part is produced, having end sections 13 that are decreased in diameter and tripod stars that are compression-molded on. Subsequently, the contour of the tripod stars 2 is pre-milled, and the inside contour 25 of the tripod rings 21 is pre-lathed to fit with an allowance. Subsequently, the entire component is copper-coated using an immersion method. Now the tripod journals 22 are re-milled to remove the copper layer and subjected to a hardening process, during which process heat-treatment of the tripod journals 22 using low-pressure carburization takes place. In this way, a hard surface of the tripod journals 22 is achieved, with a soft inner core. The tripod journals are now milled to their final contour. Optionally, the shaft body 11 can now be freed of the copper layer. Subsequently, the rolling units 3 with the needle bearings 21 are applied to the tripod journals 22 and axially secured with a securing ring 32.

1. A drive shaft for the drive train of a motor vehicle, comprising a shaft body (11) that is provided, on at least one end, with a tripod star (2) that has at least three tripod journals (22) for holding a rolling unit (3), in each instance, wherein the tripod star (2) is formed by a reshaped section of the shaft body (11).

2. The drive shaft according to claim 1, wherein the shaft body (11) is configured to be hollow, in particular tubular.

3. The drive shaft according to claim 2, wherein the shaft body (11) has a thicker wall thickness in an end section (13) that precedes the tripod journals (22) of the tripod star (2) as compared to a central, preferably cylindrical section (12).

4. The drive shaft according to claim 1, wherein the tripod journals (22) are configured to be cylindrical.

5. The drive shaft according to claim 1, wherein the drive shaft (1) is produced from a steel alloy.

6. The drive shaft according to claim 1, wherein the tripod star (2) has three tripod journals (22) distributed regularly over the circumference.

7. The drive shaft according to claim 1, wherein the shaft body (11) has two ends and a tripod star (2) at the two ends, wherein the tripod journals (22) of the two opposite tripod stars (2) are arranged offset from one another.

8. The drive shaft according to claim 1, wherein the tripod journals (22) hold a rolling unit (3), in each instance, wherein the rolling unit (3) comprises a plurality of rolling bodies and is preferably formed by means of a needle bearing (31).

9. The drive shaft according to claim 1, wherein the tripod journals (22) are configured to be hardened.

10. The drive shaft according to claim 1, wherein the tripod journals (22) are provided with an axial bore (23).

11. A method for the production of a drive shaft according to claim 1, wherein a tripod star (2) is formed on a metal tube, in particular a steel tube, on at least one end, by means of reshaping, wherein the tripod star (2) has at least three tripod journals (22) that are arranged to run circumferentially, and afterward the tripod star (2) is finished using a chip-removing method.

12. The method according to claim 11, wherein the tripod journals (22) are provided with an axial bore (23).

13. The method according to claim 11, wherein the at least one tripod star (2) is hardened, at least in the region of the tripod journals (22).

14. The method according to claim 14, wherein the drive shaft is provided with a copper layer, at least in certain regions, before hardening.
